(19) United States
(12) Patent Application Publication
(10) Pub. No.: US 2021/0206202 A1
(43) Pub. Date: Jul. 8, 2021

(54) Vehicle traction mat apparatus

(71) Applicant: Robert Harrington, Asheville, NC (US)

(72) Inventor: Robert Harrington, Asheville, NC (US)

(21) Appl. No.: 17/300,105

(22) Filed: Mar. 10, 2021

Related U.S. Application Data
(63) Continuation-in-part of application No. 15/998,325, filed on Aug. 7, 2018.

(51) Int. Cl. B60B 39/12

(52) U.S. Cl. CPC B60B 39/12; B60B 2900/721; B60B 2900/551

(57) ABSTRACT

A vehicle traction mat in the form of an elongated body member having a top surface with protruding upright gripper members or cleats for engagement by a vehicle wheel or tire includes a storage receptacle with a removable cover intercepting the top surface of the elongated body member, and further includes a reinforcing insert member adapted to be placed into the storage receptacle after removal of the cover and fastened in place to the elongated body member to provide enhanced stiffness and strength to the vehicle traction mat.

### RELATED APPLICATION

The present application is a continuation-in-part and claims priority for all purposes on and of my prior co-pending non-provisional application Ser. No. 15/998,325; filed Aug. 7, 2018, entitled: Vehicle Traction Mat Apparatus. To perfect this claim, a duly executed Application Data Sheet Under 37 CFR 1.76 is being filed concurrently with this application. The aforementioned prior pending non-provisional application Ser. No. 15/998,325; etc. and the Application Data Sheet hereby are incorporated in and made part of this CEP application.

### FIELD OF THE INVENTION

The present invention relates generally to generally to vehicle wheel friction enhancement devices, and more particularly to a portable traction mat or tread for emplacement between the driven wheel of a vehicle when slippery ground conditions are encountered such as might be caused by ice, snow, mud, loose soil or the like.

### DESCRIPTION OF THE PRIOR ART

Many portable traction mat devices have been proposed in the past as exemplified by the following prior U.S. Pat. No. 2,225,828 (Godshall), U.S. Pat. No. 2,486,911 (Becker), U.S. Pat. No. 3,025,002 (Kunz), U.S. Pat. No. 3,342,414 (Jureit), and U.S. Pat. No. 3,836,075 (Botbol), each of which hereby is incorporated herein by this reference. While these devices generally are satisfactory for providing enhanced traction between the wheel of a vehicle under certain imperfect or adverse road or ground conditions, further room for improvement exits.

### BRIEF DESCRIPTION OF THE INVENTION

It is therefore a primary object of the present invention to provide an improved vehicle traction mat apparatus that advances the state of the art by combining in a unitary device several unique advantageous features unforeseen by the various traction mat devices of the prior art exemplified above. In brief, the traction mat of the present invention provides in combination: (i) an elongated molded plastic shell of body member having a fop surface supporting rows of treads of, cleats for engagement by the vehicle wheel or tire; (ii) inclined fore and aft edges for helping to wedge the mat between the ground and the wheel or tire; (iii) carry handles on the periphery of the body member, (iv) one or more rows of openings in the top surface for receiving additional or replacement tread or cleat elements, and (v) a storage receptacle located between the rows of cleats on the top surface for containing various accessories which may be required during use of the device such as cable ties for attaching a plurality of traction mats together to create a roadway, ground spikes for attaching the traction mat to the roadbed, and the aforementioned additional or replacement tread or cleat; elements capable of being attached to the top of the traction mat as and when desired. In an alternatively preferred embodiment, a stiff, rigid, high-strength reinforcement member of suitable shape and configuration is provided for selective insertion into die storage compartment in order, to enable the traction mat of the present invention to suitably function as a bridging member when rough or rocky terrain is encountered.

Another object of the present invention is to provide a novel vehicle mat traction device or apparatus of the foregoing type which is simple in its construction, comparatively inexpensive in its manufacture, thoroughly efficient and reliable in it use and operation, and otherwise well adapted to the purpose for which it is designed.

The above and numerous other objects of the invention will become evident from the following more detailed description of the invention, taken with reference to the annexed drawings.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a top plan view of the traction mat apparatus of the present invention.

FIG. 2 is a bottom plan view of the apparatus of FIG. 1.

FIG. 3 is cross-sectional view taken along line 3-3 in FIG. 1.

FIG. 4 is a schematic elevational view showing a vehicle in use with the traction mat of the present invention.

FIG. 5 is a top plan view schematically showing a pair of traction mat members attached together by cable ties to create a roadway.

FIG. 6 is a top plan view schematically showing a pair of traction mat members attached together by cable ties side-by-side for use with dual-wheel vehicles.

FIG. 7 is a side elevational view schematically showing a pair of traction mat members being stacked together for easy compact storage.

FIG. 8 is an enlarged fragmentary perspective view of the top of the traction mat of FIG. 1 showing the treads or cleats protruding from the top surface thereof among other features.

FIG. 9 is an exploded perspective view schematically showing an additional tread or cleat being fastened in its associated reception opening in the top wall of the traction mat of the invention.

FIG. 10 is an elevational exploded view of an alternatively preferred embodiment of the present invention where a reinforcement insert member is adapted to be placed into the storage compartment of the traction mat apparatus of the present invention.

FIG. 11 is top plan view of the reinforcement insert member taken along lines 11-11 of FIG. 10.

FIG. 12 is an end view of the reinforcement insert member taken along lines 12-12 of FIG. 10.

FIG. 13 is a bottom plan view of the alternatively preferred embodiment of FIG. 10 taken along lines 13-13 of FIG. 10.

FIG. 14 is an elevation view of the alternatively preferred embodiment of the present invention partially broken away to schematically depict the fastener members for the reinforcement insert member extending upwardly through the storage compartment bottom wall of the fraction mat apparatus of the present invention.

FIG. 15 is a cross-sectional view taken along lines 15-15 of FIG. 14 showing the disposition of the reinforcement insert member fastened in place within the storage compartment of the traction mat apparatus of the present invention.

FIG. 16 is an exploded perspective view of the alternatively preferred embodiment of the present invention schematically showing the reinforcement insert member, the open storage compartment of the fraction mat apparatus, and the fastener members employed to affix the parts together in accordance with the present invention.

FIG. 17 is an exploded perspective view showing the various parts making up the reinforcement insert member of the alternatively preferred embodiment of the present invention.

FIG. 18 is a schematic depiction in perspective showing how the reinforced traction mat apparatus of the alternatively preferred embodiment of the present invention suitably functions as a bridging member or span suitably supporting the weight of a vehicle wheel in rocky terrain.

FIG. 19A is an exploded elevational view showing the female well nut portion before being crimped into place in a recess in the bottom tube portion of the reinforcing insert of the alternatively preferred embodiment of the present invention and the crimping tool to be used therewith.

FIG. 19B is an exploded elevational view showing the female well nut portion after it has been crimped in-place in a recess in the bottom tube portion of the reinforcing insert of the alternatively preferred embodiment of the present invention, and further shows the fastener assembly employed in accordance with the invention to secure the insert and insert tube to the bottom wall of the storage compartment of the traction mat shell member of the present invention.

### DESCRIPTION OF THE PREFERRED EMBODIMENTS

With reference to the drawings, a new and improved vehicle traction mat apparatus embodying the principles and concepts of the present invention now will be described.

Turning initially to FIGS. 1-4, 8 and 9, there is shown a preferred embodiment of the vehicle traction mat apparatus of the invention generally designated by reference numeral 10. In each of the Figures, reference numerals are shown that correspond to like reference numerals that designate like elements shown in other Figures.

In accordance with the preferred embodiment illustrated, our vehicle traction mat apparatus comprises a substantially rectangular-shaped tread member in the form of a shell or body member generally represented by reference sign 10. Shell member 10 is characterized by a raised top wall 12, a pair of fore and aft opposed inclined end walls or ramps 14, 16, and a pair of opposed inclined side walls 18, 20, substantially as depicted. Preferably, shell member 10 is fabricated of a stiff, durable molded polymeric material, with glass-filled nylon being mostly preferred, although other suitable material may be used as well.

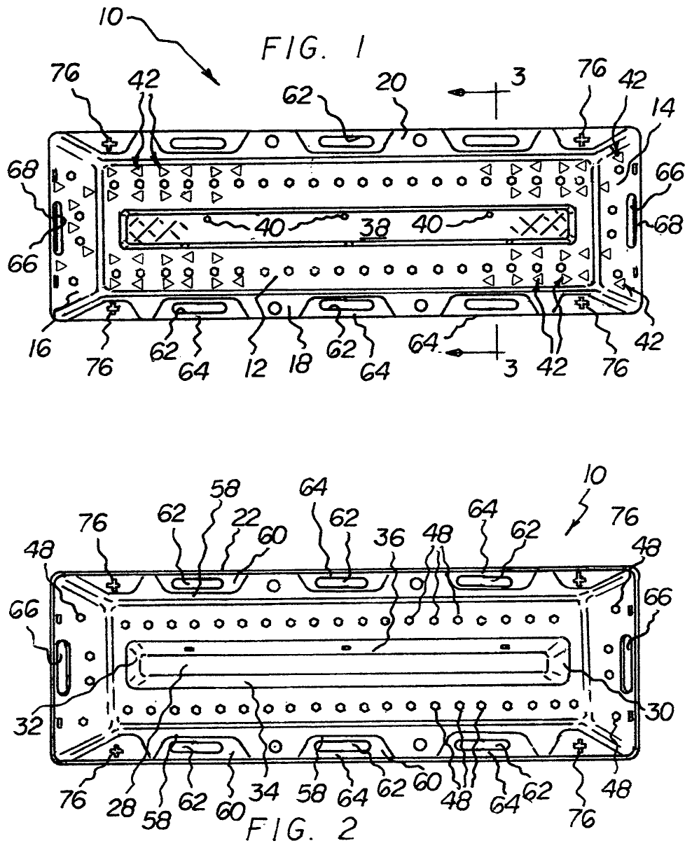

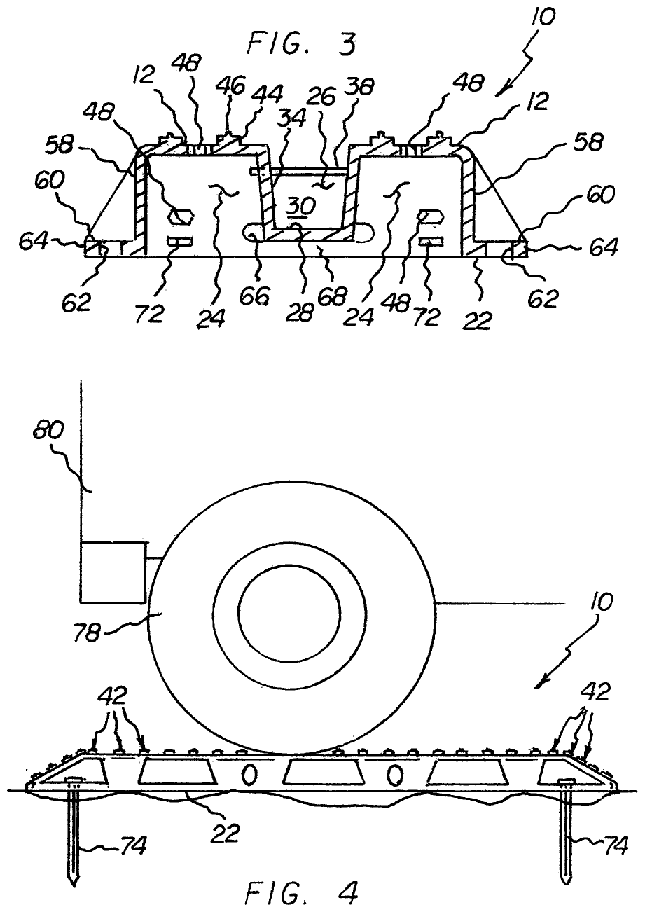

The bottom of the shell member 10 is generally concave and is bounded peripherally by a continuous annular ground-engaging rim 22. Thus, top wall 12 extends longitudinally along the top of the tread in raised disposition with respect to rim 22 to define an interior space 24 underneath the top wall bounded by the top wall 12 and the opposed side walls 18, 20 (FIG. 3). In accordance with an important feature of the invention, a storage compartment or receptacle 26 depends downwardly from the top surface defined by top wall 12 and protrudes into interior space 24, substantially as depicted. Storage compartment 26 has a bottom wall 28, first and second opposed end walls 30, 32, and first and second opposed side walls 34, 36 integrally molded to and forming part of top wall 12 (FIGS. 2 and 3). The storage compartment 26 is located centrally on the imaginary central axis (not shown) of traction mat body shell 10 and spans almost the full longitudinal extent of the top wall 12 as substantially depicted in FIGS. 1 and 2. A substantially flat, removable cover 38 for the storage compartment 24 is fastened between side walls 34, 36 and end walls 30, 32 in a slightly recessed disposition relative to top wall 12 by a series of three spaced thumb screws 40 (FIGS. 1 and 8). The purpose of the storage compartment is to store accessories for the traction mat as will be explained in more detail below.

The central location of storage compartment 24 divides the top wall 12 into two substantial parallel spaced “tread sections” upon which are disposed a series of spaced “molded in place” protruding gripper elements 42 for suitably frictionally engaging the tire of a vehicle wheel. Similar gripper elements 42 are disposed in a suitable spaced array on the inclined end walls or ramps 14, 16. Each gripper element has a base portion 44 characterized by a generally triangular-shaped transverse cross-section and a protruding spike member 46 extending upwardly from base portion 44 generally centrally thereon.

Preferably, the spaced protruding gripper elements 42 are disposed in spaced juxtaposed rows, two on either side of the storage compartment 24, as best seen in FIG. 8. Also, it will be noted, to enhance friction between the rows of gripper elements 42 and the vehicle tire, each successive pair of gripper elements 42 in a given row preferably is oriented such that opposed flat sides on the adjacent base portions in such successive pair confront each other, respectively, and are disposed substantially orthogonally with respect to the longitudinal axis of the shell member 10 and the direction of each such row (FIG. 8). That is, the confronting base portion sides are generally parallel to each other whereas the apex portions on each base portion opposite to such base portion sides, respectively, point oppositely and away with respect to each other in alignment with the longitudinal axis of the shell member 10.

In accordance with another important feature of the invention, top wall 12 includes a plurality or series of hexagonally-shaped spaced through-openings 48 extending longitudinally along top wall 12 between the spaced rows of protruding gripper elements 42 and essentially parallel thereto with one such hexagonally-shaped opening being located between each pair of juxtaposed adjacent gripper elements 42 from the two adjacent rows, respectively (FIGS. 3 and 8). Similar hexagonally-shaped through-openings 48 suitably are provided in end walls or ramps 14, 16, respectively.

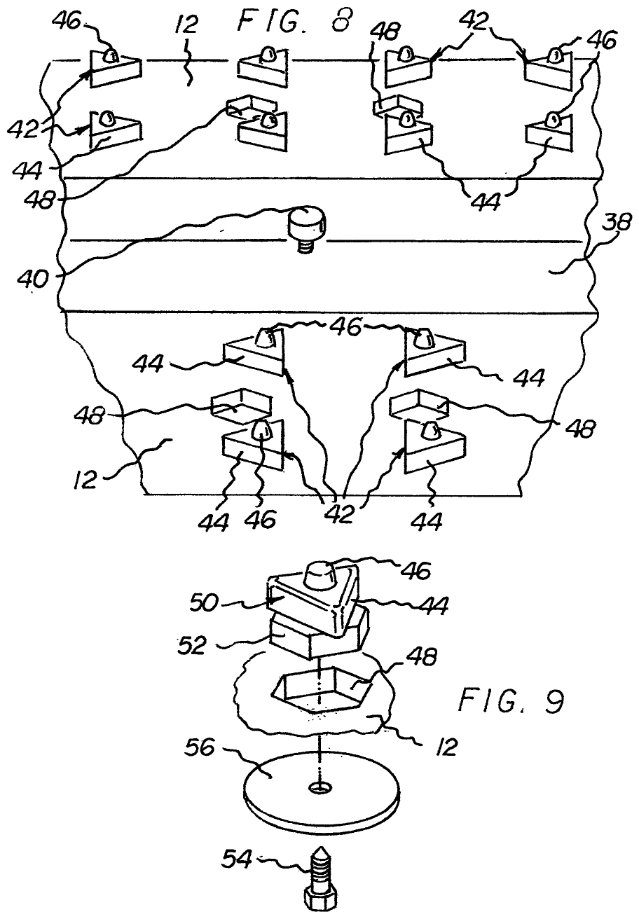

As a result of the foregoing arrangement, “supplemental” gripper elements indicated generally by reference sign 50 (FIG. 9) can be provided for selective fastening attachment to the top wall 12 and/or end walls 14, 16. Each supplemental gripper element 50 comprises a molded module consisting of the usual triangular-shaped base portion 44 and upwardly protruding spike member 46, but further includes a downwardly depending hexagonally-shaped sub-base member 52 molded to the bottom of base portion 44, substantially as depicted in FIG. 9. Sub-base member 52 is sized suitably to be loosely, but snuggly fitted within hexagonally-shaped through-openings 48 in top wall 12 or end ramps 14, 16. The module 50 can then be fastened in place as desired suitably using bolt fastener 54 and washer 56 and tightening these parts together from the underside of shell member 10 via a suitably tapped central opening (not shown) in the underside of sub-base member 52. In this manner, the supplemental gripper element modules 50 may be used to “retread” the top surface of top wall 12 and/or end walls 14, 16 when and if one or more original molded protruding gripper elements 42 become worn from use.

To facilitate handling the traction mat apparatus in the field, the shell member is equipped with a series of convenient carry handles. Substantially as depicted, each inclined side wall 18, 20 includes a series of three evenly spaced molded-in-place “pockets,” each comprising a vertical wall portion 58 and an intersecting flat, horizontal “foot portion” 60. A suitable oblong through opening 62 provided in each foot portion 60 defines a “side” carry handles 64 comprising the outward extremity of each foot portion bordering each oblong opening 62, respectively (FIG. 3). Similarly, each end wall 30, 32 respectively includes a suitable oblong opening 66 substantially as depicted (FIGS. 1-3) to define “end” carry handles 68 at opposed ends of the traction mat shell member 10, respectively.

In accordance with yet another important feature of the invention, “side” carry handles 64 serve the dual function of defining anchoring points for using conventional cable ties 70 or the like to connect two or more traction mat body shells 10 together in a juxtaposed or side-to-side configurations suitable for a vehicle having a dual-drive-wheel set-up (FIG. 6).

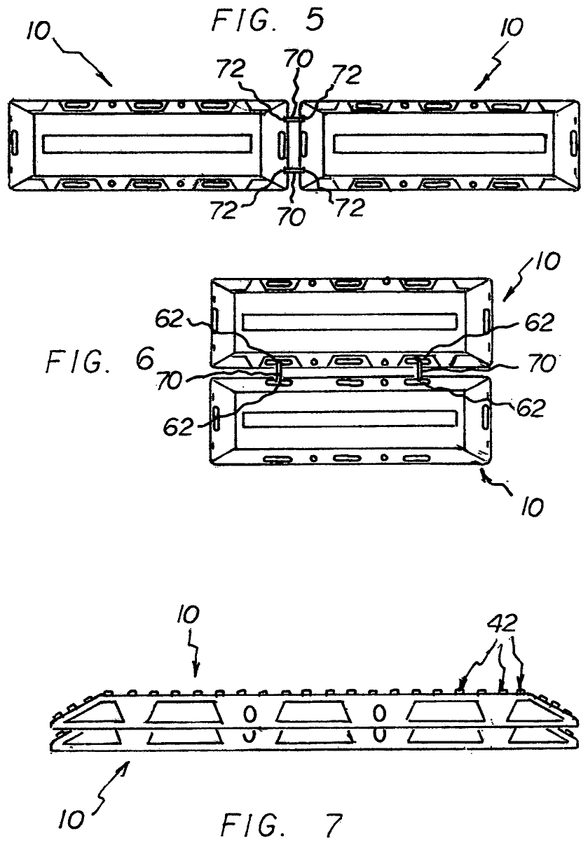

End walls 30, 32 preferably have supplemental openings 72, respectively, for receiving cable ties 70 when it is desired to connect one or more of the body shells together end-to-end to create a roadway for a vehicle wheel. This arrangement is schematically shown in FIG. 5.

To help secure the traction mat of the present invention on a roadbed, ground spikes 74 may be provided substantially as depicted in FIG. 3. Each ground spike 74 preferably has a crossed-rib transverse cross-sectional shape substantially as shown to increase its gripping ability in soil or below ground. Correspondingly, a series of complimentary-shaped through openings 76 are provided in side walls 18, 20 proximal to each corner of shell member 10, respectively, to receive the ground spikes (FIGS. 1, 2, and 4).

By virtue of its one-piece molded construction and dished bottom characteristic, a plurality of traction mat body members 10 can be conveniently stacked together vertically in a compact manner to save storage space. This advantageous “storage mode” arrangement is schematically depicted in FIG. 7. It will be appreciated in accordance with the invention, that when the traction mat body members are in “storage mode,” the storage compartment can be used to store the cable ties 70, grounds spikes 74, or other accessories.

In use, the traction mat shell or body member 10 can be used as a convenient shovel with one of the inclined end walls or ramps 14, 16 being used to remove snow, mud, loose soil or the like in the vicinity of a mired wheel/tire 78 on a vehicle 80. One of the body member's end walls or ramps 14, 16 can then be jammed against the mired wheel/tire and if necessary anchored in place with spikes 74. This will create a traction mat roadway upon which the vehicle can then safely travel un-mired in a desired direction (FIG. 4).

To further illustrate the invention without limiting same, the following dimensions are contemplated in producing a prototypical example of the traction mat apparatus of the invention:

Overall length: 44 in.
Overall width: 14 in.
Nominal wall thickness: 0.160 in.
Gripper member height: 0.250 in.
Storage box length: 32 in.

### Weight: 5.5 lbs

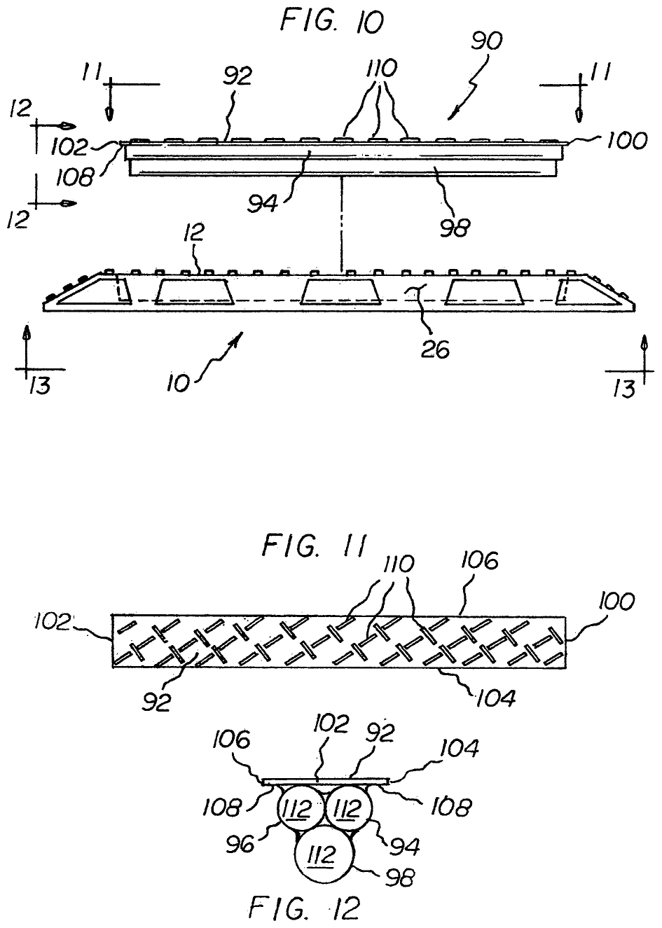

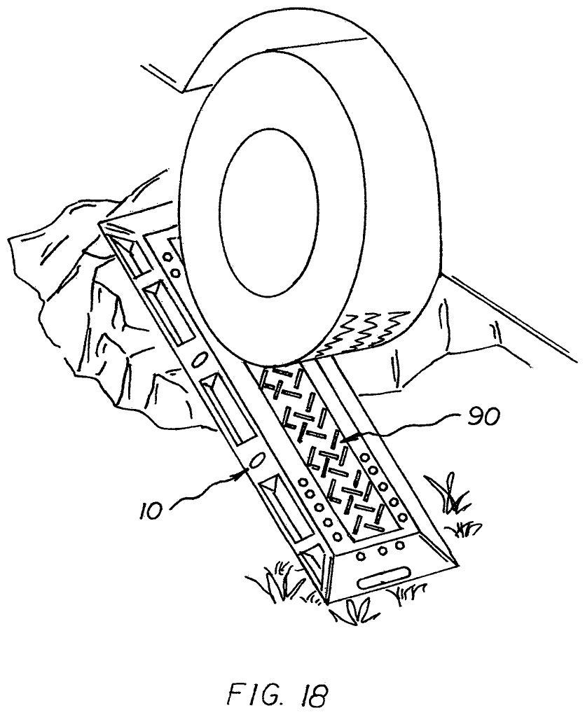

Turning now to FIGS. 10-19A and 19B of the present application, there is shown an alternatively preferred embodiment of our novel traction mat apparatus wherein a stiff, rigid and high-strength reinforcing or “bridging” member, preferably fabricated of metal, is combined with the molded plastic traction mat shell member 10. More specifically, in accordance with the invention, the reinforcing member, generally represented by reference sign 90, selectively can be combined with or inserted into the storage compartment or receptacle 24 of shell member 10 and fastened in place therein, as will be further described below.

In accordance with the present invention, reinforcing insert member 90 in its preferred form comprises a unitary assembly fabricated from a substantially rectangularly-shaped flat top plate 92, first and second hollow tubes 94, 96 of a first diameter, respectively, and a third hollow tube 98 of second diameter greater than the diameter of the first and second tubes. The first and second tubes 94, 96 are welded together in a juxtaposed fashion, and further welded to the bottom surface of top plate 92, whereas the third tube 98 is welded to the bottom of the first and second tubes 94, 96 (see FIGS. 10, 12 and 17).

Tubes 94, 96, and 98 extend parallel to each other and to the imaginary central longitudinal axis (not shown) of top plate 92 substantially the entire longitudinal extent of the top plate, terminating a short distance from the opposed end edges 100, 102 of the top plate 92, substantially as depicted in FIG. 10. Similarly, first and second tubes 94, 96 extend substantially transversely with respect to the longitudinal axis of top plate 92, terminating a short distance from the opposed side edges 104, 106 of the top plate. By this arrangement the peripheral or end and side edge portions of top plate 92 extend beyond the extremities of welded-together tubes 94, 96, 98 to form an annular, bearing surface portion 108 on the underside of top plate 92 extending peripherally and entirely around all end and side edges of the top plate (see FIGS. 10,12 and 15). This annular peripheral bearing surface portion 108, in turn is adapted to engage and rest on the corresponding annular portion on top surface 12 proximally surrounding the boundary of the opening to compartment 26 on traction mat shelf member 10 when reinforcing insert member 90 is combined with otherwise placed within the compartment 24 in accordance with the present invention, substantially as shown in FIGS. 10,15 and 16.

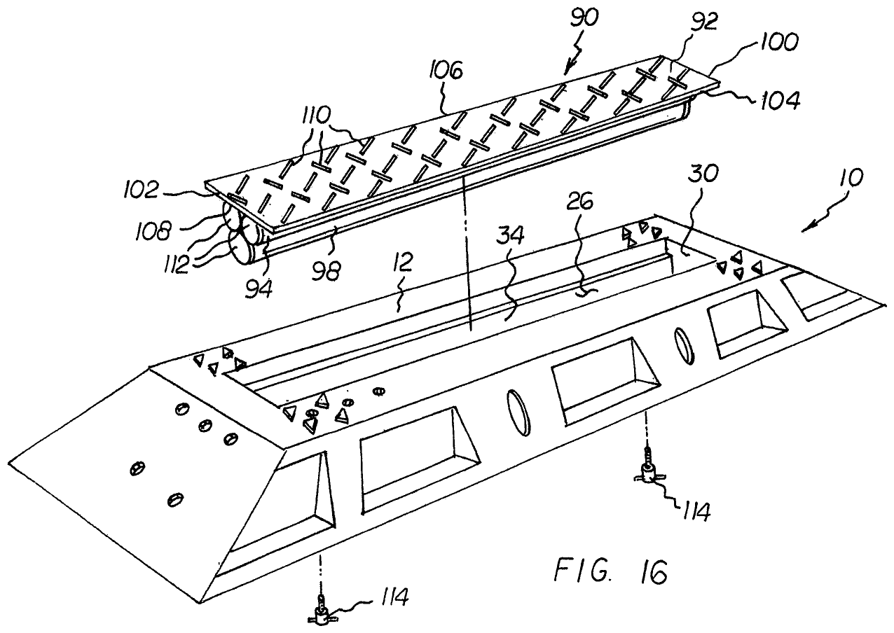

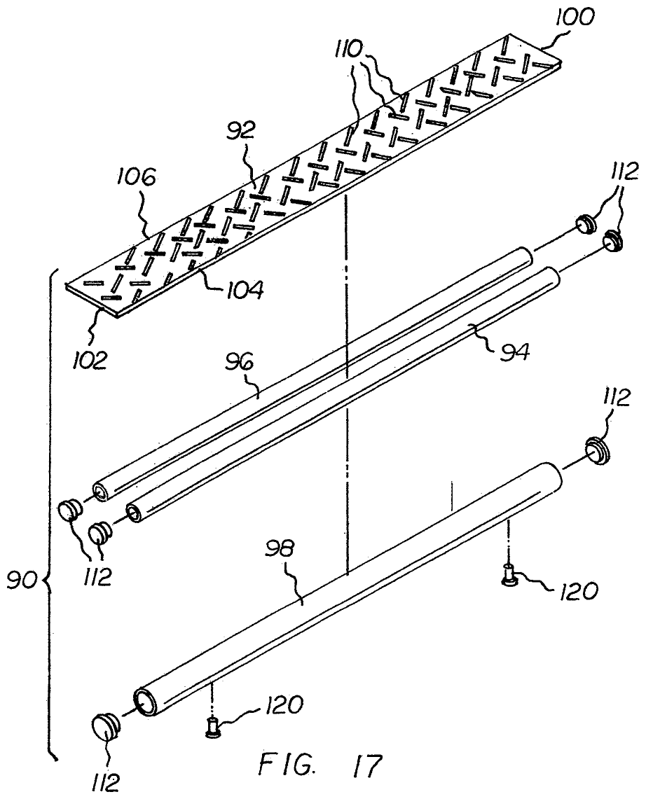

It will be understood that the insert member 90 is so shaped and dimensioned more or less as depicted such that the sub-assembly comprising tubes 94, 96 and 8 substantially fills the entire interior of the storage compartment 26 with top plate 92 substantially completely covering the opening of the storage compartment 26 on top surface 12 of shell member 10 (see FIG. 15). In use, the top plate 92 serves a “tread plate” more or less flush with top surface 12 of traction mat 10 for engaging the tire or wheel of a vehicle (see FIG. 18) whereas the hollow tubes 94, 96, and 98 affixed to the underside of the top plate 92 serve as “light weight” stiffening members for the entire reinforcing insert assembly 90.

Preferably, and substantially as depicted, the top or upwardly facing surface of top plate 92 features a pattern of upwardly-extending embossed segments 110 to enhance the friction engagement characteristic of the top plate upper surface when a vehicle wheel comes into engagement therewith as will occur to persons of obvious skill in the art. Additionally, plastic end caps 112 of suitable size, respectively; preferably can be affixed to the opposed ends of tubes 94, 96 and 98, to seal the tubes. The entire insert member 90 preferably can be coated with a layer of polyurethane to help seal the plastic end caps 112 in place and provide a rust-proof covering for the entire assembly.

It thus will be appreciated from the foregoing, that reinforcing insert member 90 generally conforms to the shape of storage compartment 26. In this respect, insert member 90 suitably is dimensioned and configured such that the bottom portion thereof made up of tubes 94, 96, 98 is insertable within the confines of storage compartment 26, and is supported therein by the engagement of the top plate edge portions 108 resting on top surface 12 of shell member 10 (FIG. 15). According to the present invention, and substantially as depicted in FIG. 15, means are provided suitably to securely and rigidly fasten the insert member 90 to the traction mat shell member 10 thereby forming a dramatically strengthened unitary traction mat assembly.

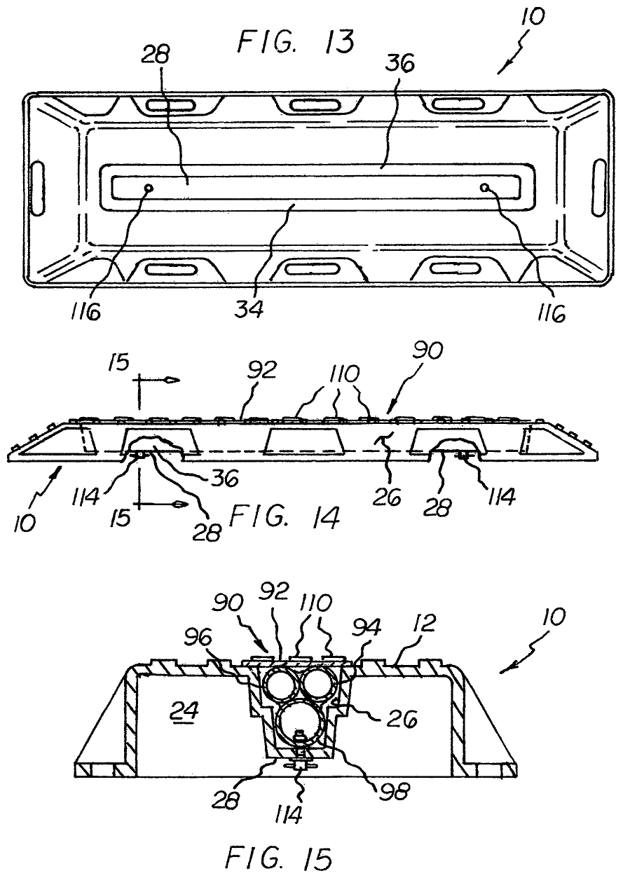

Such means preferably comprises a fastener assembly generally represented by reference sign 114, with two such assemblies preferably being deployed in spaced longitudinal disposition with respect to bottom wall 28 of storage compartment 26, substantially as depicted in FIG. 14. According to the present invention, fastener assemblies 114 extend through bottom wall 28 and engage the enlarged-diameter tube 98 of insert 90 through respective pairs of aligned openings suitably formed in the bottom wall 28 and in the hollow tube 98, respectively (FIGS. 13, 14 and 15). More specifically, each pair of aligned openings comprises a first opening 116 in bottom wall 28, and a co-axial second opening 118 in the bottom portion of the wall of hollow tube 98.

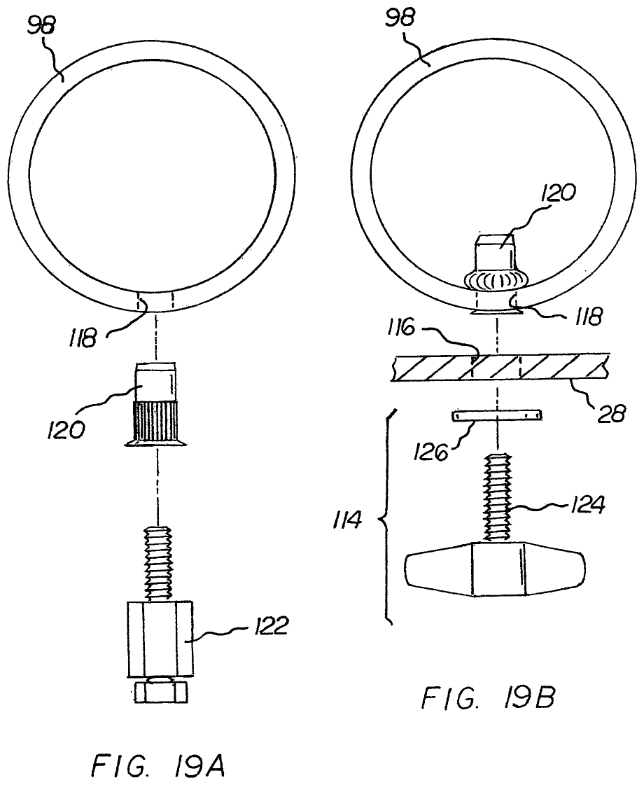

During fabrication of insert 90, a conventional “crimpable” internally-threaded well nut 120 can be inserted into each opening 118 in the wall of tube 98 by a suitable male-threaded tool 122 to form a “crimped” female-threaded fastener or “nut” secured to and in the wall of tube 98, substantially as depicted in FIGS. 19A and 19B.

To subsequently secure the reinforcement insert member 90 to the traction mat shell member 10 all that is necessary is to (i) remove cover 38 from storage compartment 26 (ii) suitably form a pair of longitudinally spaced openings 116 in bottom wall 28 of compartment 26 (FIG. 13) (iii) drop or otherwise place the reinforcement insert 90 into compartment 26 of the shell member 10 substantially as depicted in FIGS. 15 and 16, and (iv) from the bottom of the traction mat shell member 10, insert a respective fastener assembly 114 through openings 116 to engage the corresponding well nut 120 aligned therewith in openings 118 of tube 98, and tighten in place.

In this regard, it will be noted that each fastener assembly 114 preferably comprises a wing-handled male-threaded stud 124 and a lock washer 126, with each stud 124 being threadedly complimentary to each co-axially aligned internally-threaded well nut 120, respectively. Preferably, the fastener assembly 114 and the well nut 120 are formed from stainless steel to resist corrosion.

From the foregoing, it will be appreciated that the combined unit comprising traction mat shell 10 and reinforcement insert 90 is sufficiently strengthened so to be able to resist deflection under heavy vehicle loads thereby permitting the combined, reinforced and highly-strengthened traction mat of the alternatively preferred invention to be used in rocky and rough terrain as a “bridging” member substantially as schematically depicted in FIG. 18, and in general, to withstand heavy vehicle loads in use elsewhere.

To further illustrate the invention without limiting same, the following dimensions and material specifications are contemplated in producing a prototypical example of the reinforcing insert 90:

Bottom tube 98—24 in. length.×1.5 in. diameter×0.120 in. wall thickness—carbon steel pipe.

Upper tubes 94, 96—24 and ⅞ in. length.×1.0 in diameter×0.120 in wall thickness—carbon steel pipe.

Top plate 92—26.5 in. length×3.25 in. width×0.120 in. wall thickness—rolled steel plate.

It will be appreciated from the foregoing, that an important feature of the alternatively preferred embodiment of the invention just completely described is the “dual-use” nature of the storage compartment 26 provided in and intercepting top wall 12 of traction mat shell member 10. On the one hand, the removable cover 38 can be affixed to enable the storage compartment to be used as a convenient storage receptacle for supplemental replaceable gripper members, cable ties, ground stakes, or other accessories, whereas on the other hand, the cover 38 can be removed and reinforcing insert member 90 can be combined with or placed into compartment 26 and securely fastened securely to the shell member as fully disclosed above thereby yielding a traction mat of dramatically enhanced rigidity and strength when applications of the traction mat apparatus of the present invention require such desirable characteristics. It also will be noted that if needs dictate the foregoing sequence is reversible, i.e., the reinforcing insert member 90 can be removed from compartment 26 by suitably loosening the fastener assemblies 114, removing the insert member 90, then re-affixing cover 38 to storage receptacle 26.

In retrospect therefore, it will be appreciated that the present invention affords a novel apparatus for providing effective traction for a wheel or tire of a vehicle and like vehicles which is very easily and handily used, and can be economically manufactured and sold. Such a traction apparatus or device has numerous uses and can easily and successfully be utilized in any instance where it is desired to increase the traction between a driven wheel and the underlying roadway or other surface.

While particular embodiments of the invention have been illustrated and described in accordance with the Patent Statutes, it is not intended that the invention be limited to such disclosure. Numerous modifications and changes will readily occur to those skilled in the art and therefore, it is desired that the present invention be construed and limited only by the true spirit and scope of the annexed claims.

What is claimed as being new and desired to be protected by Letters Patent of the United States is as follows:

1. Vehicle traction mat apparatus comprising:
an elongated body member having a top surface,
gripper members for engagement with a vehicle wheel or tire,
wherein said gripper members are located on said top surface of said body member extending upright therefrom,
further comprising a storage receptacle, said storage receptacle opening on said top surface of said elongated body member, said storage receptacle extending below said top surface of said elongated body member, and
a reinforcing insert member, said reinforcing insert member having a first portion sized and shaped to fit at least a portion of said storage receptacle extending below said top surface of said elongated body member.

2. The apparatus of claim 1 wherein said reinforcing insert member has a top second portion for engaging said elongated body member top surface, and said reinforcing insert member first portion sized and shaped to fit at least a portion of said storage receptacle extending below said top surface of said elongated body member comprises a reinforcing insert member bottom portion for occupying said storage receptacle, and wherein said reinforcing insert member top second portion and said reinforcing insert member first portion are affixed together to form said reinforcing insert member.

3. The apparatus of claim 2 wherein said reinforcing insert member top second portion comprises a top plate and said reinforcing insert member bottom portion for occupying said storage receptacle comprises at least one hollow tube affixed to said top plate.

4. The apparatus of claim 3 wherein said reinforcing insert member bottom portion additionally comprises second and third hollow tubes, said second and third hollow tubes being affixed to said top plate in juxtaposed relation to each other and said top plate, and wherein said at least one hollow tube is affixed jointly to said second and third tubes.

5. The apparatus of claim 4 wherein said top plate has an imaginary longitudinal axis, and said at least first hollow tube and said second and third hollow tubes extend parallel to each other and to said imaginary longitudinal axis of said top plate.

6. The apparatus of claim 5 wherein said second and said third hollow tubes each has a first diameter, respectively, said at least first hollow tube has a second diameter, and wherein said second diameter is greater than said first diameter.

7. The apparatus of claim 3 wherein said storage receptacle extending below said top surface of said elongated body member has a bottom wall, wherein said bottom wall has an opening, further including a removable fastener member extending through said opening in said bottom wall, said removable fastener member engaging said at least one hollow tube affixed to said top plate to thereby removably affix said elongated body member to said reinforcing insert member bottom portion.

8. The apparatus of claim 2 wherein said elongated body member is fabricated of molded plastic and said reinforcing insert member is fabricated of metal.

9. The apparatus of claim 2 wherein said storage receptacle has a removeable cover for said opening on said top surface of said elongated body member, and wherein said reinforcing insert member first portion is fitted in said at least a portion of said storage receptacle extending below said top surface of said elongated body member after said removable cover is removed.

10. The apparatus of claim 9 wherein said reinforcing insert member top second portion engages said elongated body member top surface when said reinforcing insert member first portion is fitted in said at least a portion of said storage receptacle extending below said top surface of said elongated body member.
